(19) United States
(12) Patent Application Publication
(10) Pub. No.: US 2006/0065137 A1
(43) Pub. Date: Mar. 30, 2006

(54) Preferential orientation system for golf balls

(76) Inventors: Chung H. Nguyen, East Longmeadow, MA (US); Mark A. Cloutier, Wilbraham, MA (US)

Correspondence Address: MICHAEL A. CATANIA;CALLAWAY GOLF COMPANY, 2180 RUTHERFORD ROAD, CARLSBAD, CA, 92008-7328, US

(21) Appl. No.: 11/234,710

(22) Filed: Sep. 23, 2005

Related U.S. Application Data
(60) Provisional application No. 60/613,582, filed on Sep. 27, 2004.

(51) Int. Cl. B41F 17/00

(52) U.S. Cl. 101/35

(57) ABSTRACT

A visual inspection, mapping and orientation method and system (500) for golf balls (20) is disclosed. The visual inspection and mapping equipment locates unique features on the surface of the golf bail (20) and then uses the features to orient the golf ball (20) in a particular manner in preparation for providing one or more indicia (32) on the golf ball (20). The present invention eliminates the need to manually inspect and orient golf balls (20) so that the indicia (32) can be provided in the same location on each of a multitude of golf balls (20).

### CROSS REFERENCES TO RELATED APPLICATIONS

The present Application claims priority to U.S. Provisional Patent Application No. 60/613,582, filed on Sep. 27, 2004.

### STATEMENT REGARDING FEDERALLY SPONSORED RESEARCH OR DEVELOPMENT

Not Applicable

### BACKGROUND OF THE INVENTION

1. Field of the Invention

The present invention relates to finishing a golf ball. More specifically, the present invention relates to a method and system for orienting a golf ball for printing of an indicia on a predetermined location of the surface of the golf ball.

2. Description of the Related Art

Golf balls have indicia such as logos, brand names, numbers, and the like to identify the golf ball as well as its source of origin, and to advertise a particular brand or event. Many golf balls have multiple indicia, such as a brand name (for example, TOP-FLITE or CALLAWAY GOLF), a logo or sub-brand name, a number, and other features. Often, it is desirable to have the particular indicia oriented the same way on all of the balls of a particular type or brand. For example, if an arrow or other indicia is printed on a ball, it might be desirable to always have it pointing in a particular direction, for example, at the pole or the equator of the ball.

Currently, orienting the golf balls in a particular orientation based on a cover surface feature is achieved manually, and this is very time consuming and labor intensive. For example, if it is desirable to stamp particular indicia facing a particular dimple or location on the ball, the ball must be manually oriented and placed in the stamping machine. Visual inspection systems have been used to orient golf balls using other stamped indicia. For example, a visual inspection system may use the brand name to orient a ball such that an additional logo can later be stamped on the ball in a particular location that is not on or near the brand name.

As previously noted, it is known to use visual inspection systems to orient a golf ball using other logos or stamps on the ball. It is also known to use visual inspection systems to inspect golf balls and reject them in-line, thus allowing the indicia to be removed before curing and reprinted. See, for example, U.S. Pat. No. 6,462,812 to Heene et al. However, the visual inspection system operates to inspect the printed indicia for quality, not to orient a ball based on specific cover surface features on the ball.

There are currently no visual inspection systems that orient golf balls in a desired orientation based upon cover surface features on the golf ball. Accordingly, it would be desirable to develop a visual inspection system wherein surface features on a ball, such as a particular dimple, the equator line, mold identification marks or stamps, and the like, can be used to map the golf ball and orient it in a desired orientation for stamping of indicia.

### BRIEF SUMMARY OF THE INVENTION

On aspect of the present invention is a method for orienting a golf ball for a placement of an indicia thereon. The method begins with transferring a golf ball to a first vision station. The golf ball has a surface with an identifiable surface feature. Next, the golf ball is retained within a first pair of clamps, each clamp of the pair of clamps engages a portion of the surface of the golf ball. Next, the golf ball is rotated about a central axis at the first vision station. Next, a first viewable portion of the surface of the golf ball is mapped with at least one camera at the first vision station. Next, the golf ball is transferred to a second vision station. Next, the golf ball is oriented ninety degrees relative to an orientation of the golf ball at the first vision station. Next, the golf ball is rotated about a central axis at the second vision station. Next, a second viewable portion of the surface of the golf ball is mapped with at least one camera at the second vision station. Next, a digital map of the surface of the golf ball is created by a microprocessor. Next, the location of the identifiable surface feature of the golf ball is located from the digital map of the surface of the golf ball. Next, the golf ball is transferred to a third vision station. Next, the location of the identifiable surface feature of the golf ball is confirmed at the third vision station. Next, the golf ball is transferred to an orienting station. Next, the golf ball is oriented with reference to the at least one identifiable surface feature for printing of an indicia on a predetermined location of the surface of the golf ball. Next, the golf ball is transferred to a printing station. Finally, an indicia is printed on the predetermined location of the surface of the golf ball at the printing station.

The at least one identifiable surface feature is preferably selected from the group of a deep dimple, a plurality of deep dimples, an equator of the golf ball, a pole of the golf ball, a position mid-way between a pole of the golf ball and an equator of the golf ball, an unique contour of the surface of the golf ball, or a specific dimple pattern.

The surface of the golf ball preferably includes a plurality of dimples and land area. Alternatively, the surface of the golf ball includes a plurality of tubular lattice structures.

Another aspect of the present invention is a method for orienting a golf ball for a placement of an indicia on a predetermined location on the surface of the golf ball. First, the golf ball is transferred to an orientation apparatus. The golf ball has at least one identifiable surface feature. Next, an entire surface of the golf ball is scanned to create a digital map of the entire surface of the golf ball. Next, the location of the at least one identifiable surface feature is determined from the digital map of the entire surface of the golf ball. Next, the golf ball is oriented relative to the location of the at least one identifiable surface feature for printing of an indicia on a predetermined location of the surface of the golf ball. Finally, an indicia is printed on the predetermined location of the surface of the golf ball.

Yet another aspect of the present invention is a system for orienting a golf ball for placement of an indicia thereon. The system includes a conveyer, an orientation apparatus, a digital map creating means, a location determining means, a orienting means and a printing means. The conveyor for transfers the golf ball to the orientation apparatus. The location determining means determines the location of the at least one identifiable surface feature on the surface of the golf ball from the digital map of the entire surface of the golf ball. The orienting means orients the golf ball relative to the location of the at least one identifiable surface feature for printing of an indicia on a predetermined location of the surface of the golf ball. The printing means prints an indicia on, the predetermined location of the surface of the golf ball.

The location determining means preferably includes at least one camera and a microprocessor for comparing the digital map of the entire surface of the golf ball to a real-time image of at least a portion of the golf ball.

The printing means is preferably a pad-printing machine.

Yet another aspect of the present invention is a system for orienting a golf ball for placement of an indicia thereon. The system includes a conveyor, an orientation apparatus, a plurality of cameras, a microprocessor, a location determining means, an orienting means, and a printing means.

Having briefly described the present invention, the above and further objects, features and advantages thereof will be recognized by those skilled in the pertinent art from the following detailed description of the invention when taken in conjunction with the accompanying drawings.

### BRIEF DESCRIPTION OF THE SEVERAL VIEWS OF THE DRAWINGS

FIG. 1 is a side view illustrating a preferred embodiment of a system of the present invention.

FIG. 2 is a cross-sectional view illustrating a golf ball having a core and a cover layer having dimples, wherein one or more of the dimples extends more deeply into the cover.

FIG. 2A is a diametrical cross-sectional view of the golf ball of FIG. 2.

FIG. 3 is a top view illustrating a logo on a golf ball having dimples wherein a logo is oriented such that the arrow portion of the logo points to a deep dimple;

FIG. 4 is a perspective view of a golf ball illustrating three deep dimples in one hemisphere of a golf ball;

FIG. 5 is a perspective view of a golf ball illustrating a mold mark in the cover of a golf ball; and

FIG. 6 is a two-dimensional view of the surface of a golf ball that has been mapped by the camera of the inspection system of the invention.

FIG. 6A is another two-dimensional view of the surface of a golf ball that has been mapped by the camera of the inspection system of the invention.

FIG. 7 is a schematic side view of a printing station.

FIG. 8 is a flow chart of a specific method of the present invention.

FIG. 9 is a flow chart of a general method of the present invention.

### DETAILED DESCRIPTION OF THE INVENTION

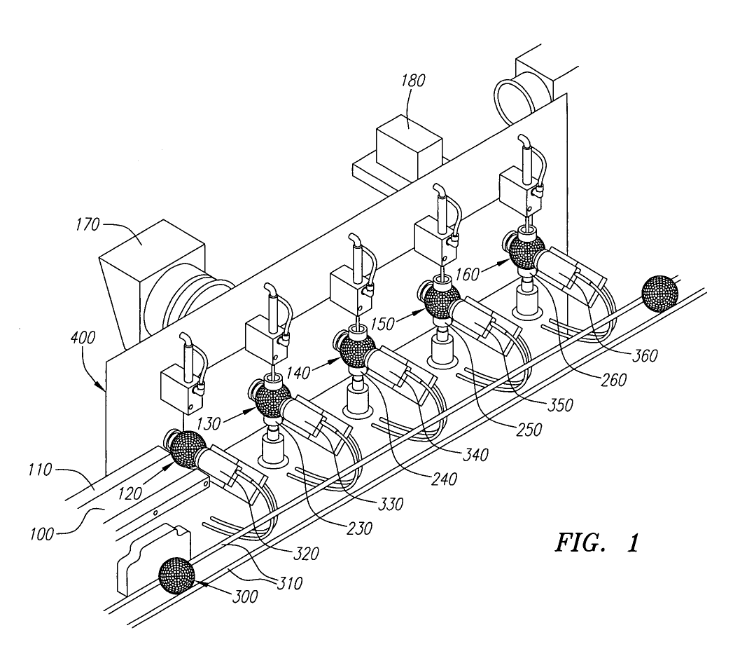

FIG. 1 is a side view illustrating a system generally designated 400. The system 400 receives golf balls from a source 100, such as a bulk hopper and/or conveyor, or any other source known in the art that will feed the golf balls to the visual inspection system. In the embodiment shown, golf balls 110 are fed to the source 100 where they are then picked up by the visual inspection system to begin the process of mapping and orienting the ball. The source 100 accumulates the balls after the balls are covered and prepared for printing of indicia. Each ball is clamped and moved or spun in front of one or more vision cameras. The camera (or cameras) maps the entire surface of the golf ball. The mapped images of the golf ball surface are used to identify and document the key features on the cover that are used to later orient the golf ball. The ball is then rotated into the desired final orientation, preferably using precision servo motors or another precision device known in the art, based on the location of the mapped surface features. The indicia are then stamped on the balls in the desired location. The invention makes it possible to stamp the desired indicia in the same location on each ball.

In the embodiment shown in FIG. 1, there is a golf ball inspection system 400. There are preferably five sets of clamps (320, 330, 340, 350 and 360), but any desired amount can be used, as long as the mapping and orientation is accomplished. In the embodiment shown, each set of clamps (320, 330, 340, 350 and 360) has a golf ball (120, 130, 140, 150 and 160). A golf ball 120 is clamped by the first set of clamps 320. The golf ball 120 is then moved into the first station 230 by rotating the clamps 320. Each of the other clamps 330, 340, 350 and 360 also rotates at the same time, moving the respective golf balls one station forward. In stations 230 and 240, camera 170 scans golf balls 130 and 140 simultaneously and maps the surfaces of the balls as they are spun. A mirror assembly (not shown) allows camera 170 to scan the golf balls in the first and second stations (230 and 240) at the same time. Lights 200 and 210 are used to make it easier for the camera 170 to scan and record the surface of the balls. The balls are then moved one position forward. Golf ball 130 is scanned again (this time in position 240), along with new golf ball 120, which moves into position 230. The golf balls are scanned in two positions because portions of the ball are obscured by the upper and lower clamp pads. As a golf ball, such as golf ball 130, moves from station 230 to station 240, it is rotated ninety degrees to allow the camera to scan the remaining portions of the ball. Golf ball 140 is moved into position 350 and oriented. The system software combines the images from positions 230 and 240 to obtain the full image or map of the ball exterior. The golf ball then moves on through the remaining stations.

In the embodiment shown, golf ball 150 is moved into position 360 and oriented, and the ball is scanned by camera 180 to confirm that the orientation is as desired. At the same time, golf ball 160 is moved out of position 360 and either picked up by a robot (not shown) and moved to the printing or stamping device, or it is removed and returned to be oriented again. In one embodiment, a golf ball that is not correctly oriented can be automatically returned to the source for re-introduction into the orientation system. For example, in the embodiment shown, golf ball 300 is shown on rails 310 returning to the source 100 to be scanned and oriented again. Alternatively, the golf balls that are removed can be diverted to a storage device, such as a storage bin or container, until they can be introduced into the orientation system at a later time.

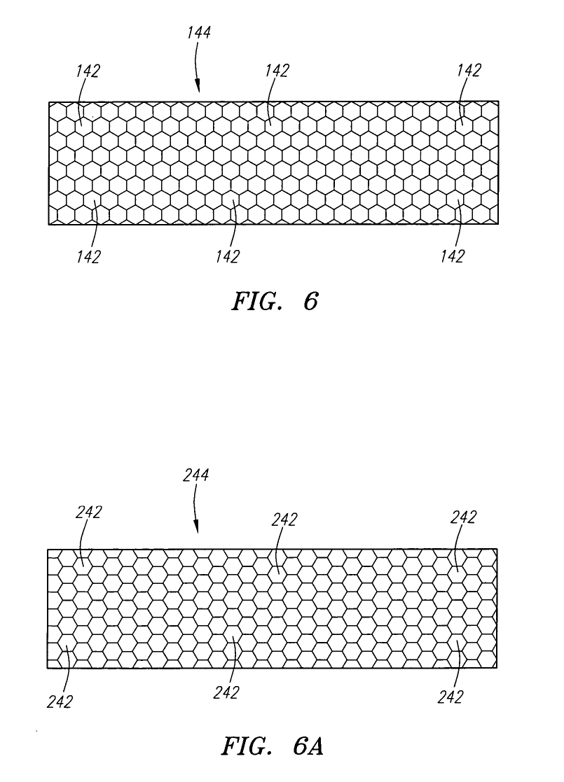

FIGS. 6 and 6A each show a two-dimensional view of the surface of a golf ball that has been mapped by the camera 170 of the inspection system 400. Deep dimples 142 are shown in golf ball surface 144, and deep dimples 242 are shown in surface 244. In each of the golf balls mapped, there were six deep dimples total.

Examples of identifiable surface features that may be used in the mapping and orienting of the golf ball include, but are not limited to, dimples having a unique or different orientation from the remainder of the dimples, such as deep dimples; equator lines; mold identification marks; letters or symbols in dimples or other locations on the ball; and the like. Preferably, dimples having an orientation that differs from the majority of the dimples, such as deep dimples, are used. As used herein, “deep dimple” refers to a dimple that has a dimple configuration wherein at least the depth of the dimple is greater than the depth of the remaining more traditional dimples. The deep dimple may be deep enough that it is to or into the next layer, such as an inner cover layer, a mantle or the core. The deep dimple is noticeably different from the other dimples and can be mapped and used to orient the golf ball. There can be any number of deep dimples in a golf ball. Preferably, there are deep dimples in both hemispheres of the golf ball, and more preferably, the number of deep dimples in the two hemispheres is the same. In some embodiments, the number of deep dimples is at least one, preferably at least two, and more preferably at least three deep dimples per hemisphere, although any number desired can be used. Different types or shapes of deep dimples may be used in combination if desired. For example, both circular and non-circular deep dimples may be used in the same golf ball. There may be additionally one or more mold marks in the cover. Alternatively, a pole location, an equator line, or some feature therebetween may be used as the identifiable feature on the surface of the golf ball 20.

Other identifiable surface features are disclosed in the following U.S. Patents, all of which are hereby incorporated by reference in their entirety: U.S. Pat. No. 5,356,150 to Lavallee et al., for a Golf Ball; U.S. Pat. No. 6,503,158 to Murphy et al., for Dual Non-Circular Dimple for Golf Balls; U.S. Pat. No. 6,620,060 to Ogg et al., for a Golf Ball; U.S. Pat. No. 6,648,778 to Sullivan et al., for a Low Spin Golf Ball Utilizing Perimeter Weighting; U.S. Pat. No. 6,695,721 to Tavares et al., for a Golf Ball Having Elongated Dimples and Method for Making the Same; U.S. Pat. No. 6,767,295 to Kennedy, mi for a Golf Ball With Undercut Dimples; U.S. Pat. No. 6,802,787 to Ogg for a Golf Ball Having a Sinusoidal Surface; U.S. Pat. No. 6,872,154 to Shannon et al., for a Golf Ball; U.S. Pat. No. 6,905,427 to Kennedy, III et al., for a Golf Ball; and co-pending U.S. patent application Ser. No. 10/709018, filed on Apr. 7, 2005, to Ogg et al., for an Aerodynamic Surface Geometry Of A Golf Ball.

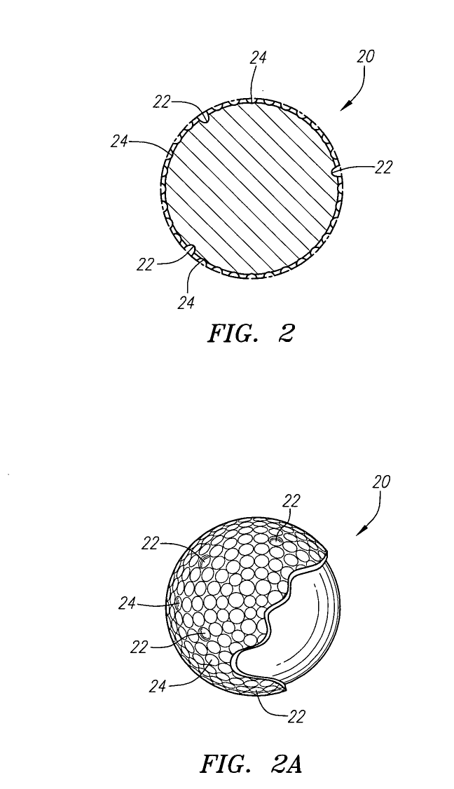

FIG. 2 illustrates a golf ball 20 having a deep dimple 22 and more traditional dimples 24 on the surface of the golf ball. FIG. 4 illustrates a golf ball 40 having three deep dimples 42, 44 and 46 located on the surface of the golf ball. In the embodiment shown, the deep dimples 42, 44 and 46 are equally spaced in a triangular pattern, but any desired pattern and spacing may be used.

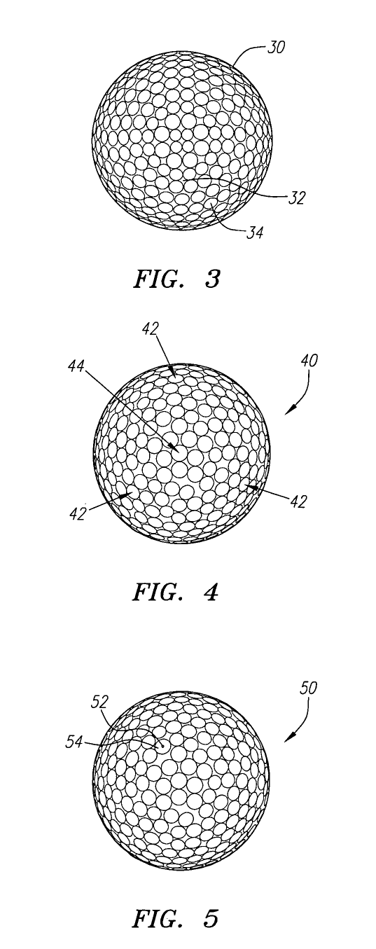

In one embodiment, it is desirable to print an indicia 32 on the ball such that it is pointing in a certain direction. For example, as shown in FIG. 3, a golf ball 30 having a chevron or arrow-like logo printed on the cover wherein the point of the chevron is pointed directly toward a deep dimple 34. The system 50 of the present invention allows the golf ball 30 to be oriented such that the point of the chevron is always pointing in the same direction, for example, at the deep dimple 34, as shown.

FIG. 5 illustrates a golf ball 50 having a mold mark 52 as an identifiable surface feature in a dimple 54. The mold mark 52 is slightly raised and is visible to the cameras.

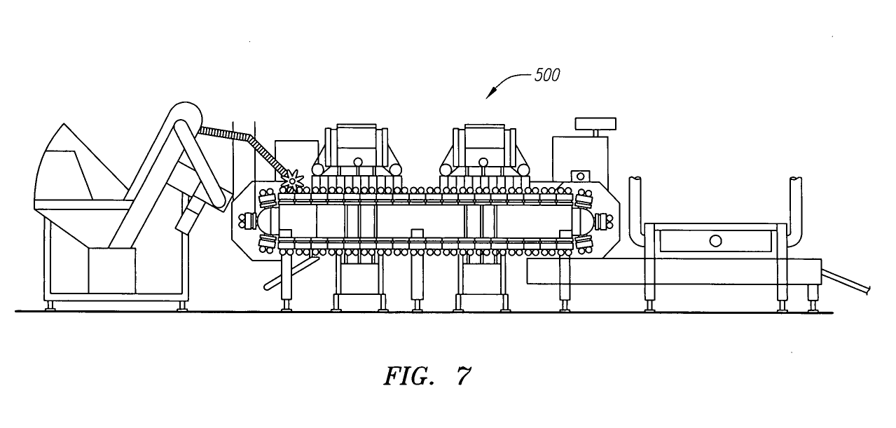

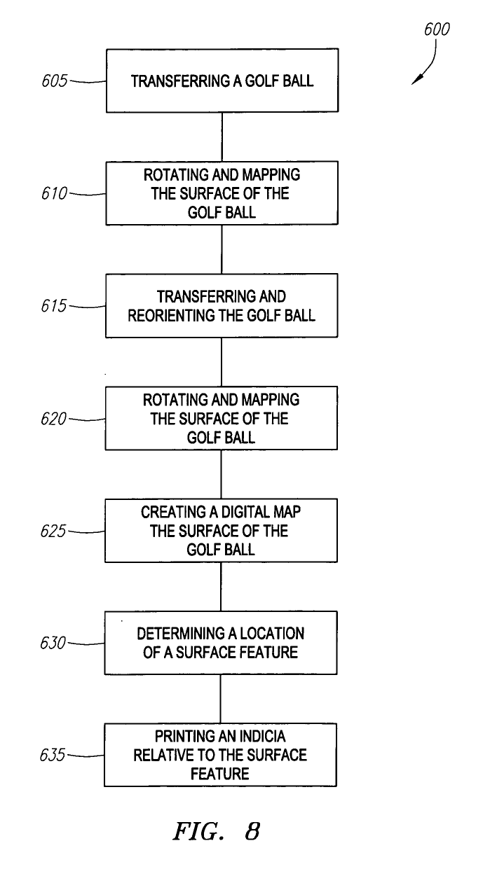

FIG. 7 illustrates a printing station 500 for printing an indicia 32 on a golf ball 20. An example of such a printing station 50 is disclosed in U.S. Pat. No. 6,462,812 to Heene et al., for a Golf Ball Indicia Verification System, which is hereby incorporated by reference in its entirety.

FIG. 8 is a flow chart of a specific method 600 of the present invention. At block 605, a golf ball 20 is transferred to a first vision station of the system 50. At block 610, the golf ball 20 is rotated within a pair of clamps about a central axis and the surface of the golf ball 20 is digitally mapped using a camera. At block 615, the golf ball 20 is transferred to a second vision station and reoriented ninety degrees to map the portion of the surface that was previously covered by the clamps at the first vision station. At block 620, the golf ball 20 is rotated and digitally mapped using a second camera. At block 625, a digital map of the entire surface of the golf ball is created from the images provided by the cameras at the first vision station and the second vision station. At block 630, a location of an identifiable surface feature is determined from the digital map of the surface of the golf ball 20. At block 635, an indicia 32 is printed on a predetermined location of the golf ball 20 in relation to the identifiable surface feature.

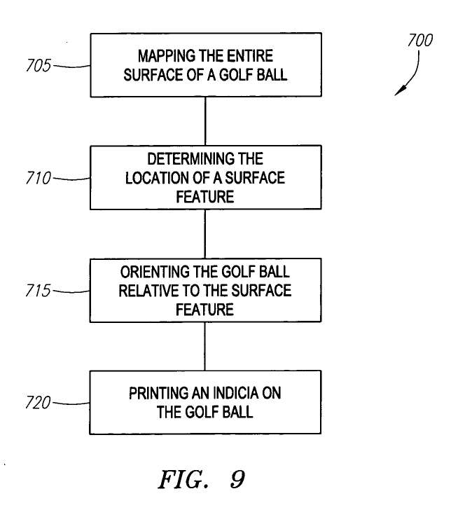

A general method 700 of the present invention is illustrated in the flow chart of FIG. 9. At block 705, the entire surface of the golf ball is digitally mapped using a plurality of cameras in electrical communication with a microprocessor. At block 710, the digital map is analyzed to determine the location of at least one or more identifiable surface features of the golf ball 20. At block 715, the golf ball 20 is oriented relative to the identifiable surface feature for printing of an indicia 32 on a predetermined location of the surface of the golf ball 20. At block 720, the indicia is printed on the predetermined location of the surface of the golf ball 20.

From the foregoing it is believed that those skilled in the pertinent art will recognize the meritorious advancement of this invention and will readily understand that while the present invention has been described in association with a preferred embodiment thereof, and other embodiments illustrated in the accompanying drawings, numerous changes, modifications and substitutions of equivalents may be made therein without departing from the spirit and scope of this invention which is intended to be unlimited by the foregoing except as may appear in the following appended claims. Therefore, the embodiments of the invention in which an exclusive property or privilege is claimed are defined in the following appended claims.

We claim as our invention:

1. A method for orienting a golf ball for a placement of an indicia thereon, the method comprising:
transferring a golf ball to a first vision station, the golf ball having a surface with an identifiable surface feature;
retaining the golf ball within a first pair of clamps, each clamp of the pair of clamps engaging a portion of the surface of the golf ball;
rotating the golf ball about a central axis at the first vision station;
mapping a first viewable portion of the surface of the golf ball with at least one camera at the first vision station;
transferring the golf ball to a second vision station;
orienting the golf ball ninety degrees relative to an orientation of the golf ball at the first vision station;
rotating the golf ball about a central axis at the second vision station;
mapping a second viewable portion of the surface of the golf ball with at least one camera at the second vision station;
creating a digital map of the surface of the golf ball;
determining a location of the identifiable surface feature of the golf ball from the digital map of the surface of the golf ball;
transferring the golf ball to a third vision station;
confirming the location of the identifiable surface feature of the golf ball at the third vision station;
transferring the golf ball to an orienting station;
orienting the golf ball with reference to the at least one identifiable surface feature for printing of an indicia on a predetermined location of the surface of the golf ball;
transferring the golf ball to a printing station; and
printing an indicia on the predetermined location of the surface of the golf ball at the printing station.

2. The method according to claim 1 wherein the at least one identifiable surface feature is a deep dimple.

3. The method according to claim 1 wherein the golf ball has a plurality of identifiable surface features.

4. The method according to claim 1 wherein the predetermined location is an equator of the golf ball.

5. The method according to claim 1 wherein the predetermined location is a pole of the golf ball.

6. The method according to claim 1 wherein the predetermined location is a position mid-way between a pole of the golf ball and an equator of the golf ball.

7. The method according to claim 1 wherein the surface of the golf ball comprises a plurality of dimples and land area.

8. The method according to claim 1 wherein the surface of the golf ball comprises a plurality of tubular lattice structures.

9. The method according to claim 1 wherein the at least one identifiable surface feature is a unique contour of the surface of the golf ball.

10. A method for orienting a golf ball for a placement of an indicia thereon, the method comprising:
transferring a golf ball to an orientation apparatus, the golf ball having at least one identifiable surface feature;
scanning an entire surface of the golf ball to create a digital map of the entire surface of the golf ball;
determining the location of the at least one identifiable surface feature from the digital map of the entire surface of the golf ball;
orienting the golf ball relative to the location of the at least one identifiable surface feature for printing of an indicia on a predetermined location of the surface of the golf ball; and
printing an indicia on the predetermined location of the surface of the golf ball.

11. The method according to claim 10 wherein the at least one identifiable surface feature is a deep dimple.

12. The method according to claim 10 wherein the golf ball has a plurality of identifiable surface features.

13. The method according to claim 10 wherein the predetermined location is an equator of the golf ball.

14. The method according to claim 10 wherein the predetermined location is a pole of the golf ball.

15. The method according to claim 10 wherein the predetermined location is a position mid-way between a pole of the golf ball and an equator of the golf ball.

16. The method according to claim 10 wherein the surface of the golf ball comprises a plurality of dimples and land area.

17. The method according to claim 10 wherein the surface of the golf ball comprises a plurality of tubular lattice structures.

18. The method according to claim 10 wherein the at least one identifiable surface feature is a unique contour of the surface of the golf ball.

19. A system for orienting a golf ball for placement of an indicia thereon, the system comprising:
a conveyor for transferring a golf ball to an orientation apparatus, the golf ball having at least one identifiable surface feature;
means for creating a digital map of the entire surface of the golf ball;
means for determining the location of the at least one identifiable surface feature on the surface of the golf ball from the digital map of the entire surface of the golf ball;
means for orienting the golf ball relative to the location of the at least one identifiable surface feature for printing of an indicia on a predetermined location of the surface of the golf ball; and
means for printing an indicia on the predetermined location of the surface of the golf ball.

20. The system according to claim 19 wherein the digital map creating means comprises a plurality of cameras.

21. The system according to claim 19 wherein the location determining means comprises at least one camera and a microprocessor for comparing the digital map of the entire surface of the golf ball to a real-time image of at least a portion of the golf ball.

22. The system according to claim 19 wherein the printing means is a pad-printing machine.

23. A system for orienting a golf ball for placement of an indicia thereon, the system comprising:
a conveyor for transferring a golf ball to an orientation apparatus, the golf ball having at least one identifiable surface feature;
a plurality of cameras and a microprocessor for creating a digital map of the entire surface of the golf ball;
means for determining the location of the at least one identifiable surface feature on the surface of the golf ball from the digital map of the entire surface of the golf ball;
means for orienting the golf ball relative to the location of the at least one identifiable surface feature for printing of an indicia on a predetermined location of the surface of the golf ball; and
means for printing an indicia on the predetermined location of the surface of the golf ball.
